(19) United States
(12) Patent Application Publication
(10) Pub. No.: US 2018/0111631 A1
(43) Pub. Date: Apr. 26, 2018

(54) INTERFACE ARRANGEMENT FOR DATA, SIGNAL AND/OR VOICE TRANSMISSION

(71) Applicant: VOITH PATENT GMBH, Heidenheim (DE)

(72) Inventor: Thomas Prill, Gehrden (DE)

(21) Appl. No.: 15/568,580

(22) PCT Filed: Apr. 25, 2016
(86) PCT No.: PCT/EP2016/059149

§ 371 Date: Oct. 23, 2017

(30) Foreign Application Priority Data
May 8, 2015 (EP) 102015107230.0

(51) Int. Cl. B61G 5/10; H01B 11/00; H02G 3/02; H01R 27/02

(52) U.S. Cl. CPC B61G 5/10; H01B 11/002; H01R 13/04; H01R 27/02; H02G 3/02

(57) ABSTRACT

An interface arrangement for data, signal and/or voice transmission between two adjacent car bodies of a multi-member vehicle, particularly a track-guided vehicle. The interface arrangement includes an electrical contact coupling associated with a first car body which has at least one coupling plane-side coupling contact for data, signal and/or voice transmission to a mating electrical contact coupling of a second car body adjacent to the first car body. In order to realize the interface arrangement particularly cost-effectively without losing its project-specific design capability, at least one coupling plane-side coupling contact is provided to be connected to a car body-side coupling contact of an electrical coupling/train interface solely by means of a data bus cabling.

### CROSS-REFERENCE TO RELATED PATENT APPLICATIONS

This patent application is a United States national phase patent application based on PCT/EP2016/059149 filed Apr. 25, 2016, which claims the benefit of German Patent Application No. DE 102015107230.0 filed May 8, 2015, the disclosures of which are hereby incorporated herein by reference in their entirety.

### FIELD

The present invention relates to an interface arrangement for data, signal and/or voice transmission. Accordingly, the invention relates in particular to an interface arrangement for data, signal and/or voice transmission between two adjacent car bodies of a multi-member vehicle, particularly a track-guided vehicle, wherein the interface arrangement comprises an electrical contact coupling associated with a first car body which has at least one coupling plane-side coupling contact for data, signal and/or voice transmission to a mating electrical contact coupling of a second car body adjacent to the first car body.

### BACKGROUND

An interface arrangement of this type for connecting electrical and/optical data and/or signal lines between two adjacent car bodies is known at least in principle in rail vehicle technology. For example, printed publication EP 0 982 215 A1 relates to an electrical contact coupling for rail vehicles which forms an interface arrangement for data, signal and/or voice transmission and which is held in longitudinally displaceable manner on a central buffer coupling. The electrical contact coupling known from this prior art comprises a support plate having a plurality of contact terminals, wherein the contact terminals are designed to form an interface for data, signal and/or voice transmission with contact terminals of a mating electrical contact coupling designed correspondingly complementary thereto.

The electrical contact couplings used in rail vehicle technology are usually arranged in the front region of the car bodies to be coupled together. They consist predominantly of metallic coupling housings with corresponding mechanisms for protecting the inner electrical components from environmental influences. These mechanisms in particular include protective flaps, sealing systems and cable glands.

The electrical components accommodated in the coupling housings of the electrical contact couplings known from the prior art and normally used in rail vehicle technology essentially consist of highly specialized coupling contacts for the transmission of different types of electrical signals as well as for transmitting energy. Reference is for example made in this context to EP 1 753 089 A2, US 2009/0004929 A1 and DE 103 10 148 B4.

Due to the stringent requirements as to mechanical durability and continuous cycle stability particularly during coupling and uncoupling, coupling contacts are a relatively cost-intensive component of the electrical contact coupling. Moreover, it is common to attach the coupling contacts to high-quality lines and cables in order to connect them to a respective electrical coupling/train interface.

The lines and cables used are usually categorized into a specific cable category pursuant to the EN 50343 (state as of date of filing) and accordingly consolidated and/or bundled. The context for this is the structural separating of cables for different purposes in line with their electromagnetic compatibility (EMC). For example, the “A” EMC cable category is intended for the cabling of power-intensive applications (e.g. current collectors, drive technology, heating) of usually higher operating voltages. Train control technology, which is mostly at the voltage level of the vehicle battery, is allocated to the “B” EMC cable category. Cabling for electronic signals, signaling devices, antenna lines and data bus systems are allocated to EMC cable category “C”. The categories can likewise be further subdivided, e.g. B1, B2 . . . Bn or C1, C2, Cn. Due to the inherent concentration of various different EMC cable categories within the realm of electrical contact couplings, increasingly close attention is being placed on train coupling components in terms of EMC.

The electrical coupling/train interface is usually physically realized by electrical plug connections or, on rare occasions, also by cable clamps in the car body. These electrical plug connections are particularly designed for high requirements in terms of environmental influences (corrosion, imperviousness, IP protection rating and mechanical sturdiness).

Due to the frequently project-specific design of electrical contact couplings, the number of variants from the different manufacturers have since become overwhelming and comparatively expensive. Electrical contact couplings already account today for the largest part of a train coupling's costs.

### SUMMARY

Consequently, the task of the present invention is to be seen as that of further developing an interface arrangement of the type cited at the outset with particular regard to being more economical to realize while still being able to be project-specifically designed as well as that of simplifying compliance with the separation requirements of EMC-relevant cable categories pursuant to EN 50343.

This task is inventively solved by the subject matter as shown and described herein.

Accordingly, in particular proposed is for a data bus cabling to connect the electrical contact coupling associated with the at least one coupling plane-side coupling contact of the first car body to a car body-side coupling contact of the electrical coupling/train interface of the first car body.

Using a data bus cabling to connect the at least one coupling plane-side coupling contact to the corresponding electrical coupling/train interface of the car body enables standardizing and normalizing at least the essential components of the interface arrangement so that it becomes possible to re-use common parts even for different, project-specific designs of the interface arrangement such that the overall costs of the electrical contact coupling or interface arrangement respectively can be significantly reduced. Furthermore, a combination of different EMC cable categories in the area of the electrical contact coupling is avoided.

The solution according to the invention relates in particular to a fundamental reconsideration of an interface arrangement for data, signal and/or voice transmission and thus to a modernizing of the electrical interface between the individual car bodies of a multi-member vehicle. The data bus cabling allows a significant reduction of the different types of coupling contacts, lines and cables (i.e. EMC cable categories) used in interface arrangements known from the prior art as well as reduces the requirements on different implementations of robust and cycle-stable electrical contact couplings. As a result, the electrical contact coupling, and thus in the broader sense also the interface arrangement, can be of significantly simplified and thereby more economical realization.

The necessary adapting thereby required to the vehicle process control structure of what has to date been multiple heterogeneous individual signals between sub-systems of the vehicle and between the car bodies so as to result in a significantly reduced number of data bus-supported connections moreover leads to improving the maintainability, diagnosability, configurability (software) and scalability as well as in significantly reducing the weight of the electrical contact coupling.

In particular, the solution according to the invention allows the increased use of fiber optic systems in the interface arrangement which enables cutting down on a considerable amount of copper in the vehicle cabling and thus reducing weight. Additional corollary effects are furthermore seen in achieving more favorable EMC properties which yields better immunibility to interference and thus a higher vehicle system integrity.

It is particularly preferentially provided for a standardized data bus cabling to be used in the inventive interface arrangement between the electrical contact coupling and the train unit, or the car body-side coupling contact of the electrical coupling/train interface respectively, to replace the cablings of different specifications normally used in known prior art interface arrangements. Doing so can considerably simplify the electrical contact coupling as well as the physical electrical coupling/train interface.

It is particularly advantageous in this context for the data bus cabling used in the inventive interface arrangement to be of a predefined standardized link class.

The link class of a cabling thereby specifies the transmission behavior for the entire transmission path. The “A,” “B,” “C” and “D” link classes were originally defined in the ISO/IEC 11801 standard (state as of date of filing) for the cabling of buildings as well as for industrial communication cabling. For example, link class “A” pertains to applications with low data rates and frequencies up to 100 kHz whereas link class “B” pertains to voice applications at frequencies up to 1 MHz, link class “C” to voice and data transmissions at frequencies of 16 MHz, and link class “D” to data transmissions at frequencies of 100 MHz. Data transmissions up to 250 MHz are defined in link class “E” and data transmissions up to 600 MHz in class “F.”

Preferably used as data bus cabling in the inventive interface arrangement is a data bus-capable cabling of the ISO/IEC 11801 “D” link class. Able to be connected here for example are Ethernet networks per IEEE802.3 Clause 25 (100Base-Tx) or IEEE802.3 Clause 40 (1000Base-T) respectively. Of course, a higher link class is however also conceivable, whereby it is always advantageous to make use of standardized data bus cabling; i.e. a data bus cabling of a link class.

For this type of simplified interface arrangement, data bus plug connections or non-contact (i.e. non-wearing) systems can be used for the coupling contacts of the electrical contact coupling; i.e. for the coupling plane-side coupling contacts. By virtue of the high transmission rates of digital data bus systems, the foregoing heterogeneous structure can be transmitted over the interface arrangement without performance loss, whereby the reliability of the transmission between two adjacent car bodies can be freely scaled by corresponding redundancy concepts.

Further expedient is the providing of physically separate transmission paths in the form of multiple parallel data bus networks particularly for the vehicle control and entertainment systems. To this end, one advantageous further development of the inventive interface arrangement provides for at least one of the transmission paths provided by the data bus cabling for data/signal transmission to be designed for a vehicle control system, wherein at least one other transmission path provided by the data bus cabling for data, signal and/or voice transmission is designed for a vehicle entertainment system.

### BRIEF DESCRIPTION OF THE DRAWINGS

The following will reference the drawings in describing example embodiments of the inventive interface arrangement in greater detail:

FIG. 1 a schematic view of a known prior art interface arrangement for data, signal and/or voice transmission between two adjacent car bodies of a multi-member rail vehicle;

FIG. 2 a schematic view of an example embodiment of an interface arrangement according to the invention for data, signal and/or voice transmission between two adjacent car bodies of a multi-member rail vehicle;

FIG. 3 an example embodiment of the inventive interface arrangement; and

FIG. 4 a further example embodiment of the inventive interface arrangement.

### DETAILED DESCRIPTION OF THE EMBODIMENTS

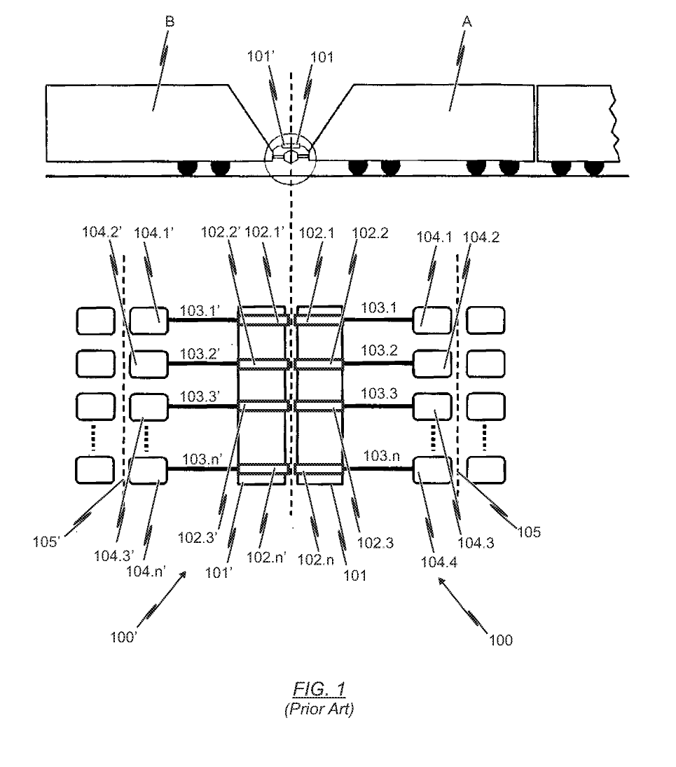

FIG. 1 shows a schematic view of an interface arrangement 100 for data, signal and/or voice transmission between two adjacent car bodies A, B of a multi-member rail vehicle as known from the prior art. The conventional interface arrangement 100 comprises an electrical contact coupling 101 allocated to the first car body A as well as a mating electrical contact coupling 101′ designed correspondingly complementary thereto and allocated to the second car body B. In the example embodiment depicted schematically in FIG. 1, the two electrical contact couplings 101, 101′ are each associated with a respective (mechanical) central buffer coupling. The coupling heads of the mechanical central buffer coupling transfer tensile and compressive forces between the adjacent car bodies A, B via during vehicle operation while data, signal and/or voice transmissions in particular occur via electrical contact couplings 101, 101′.

The FIG. 1 depiction further indicates that the electrical contact couplings 101, 101′ used in the conventional interface arrangement 100 have a plurality of coupling plane-side coupling contacts 102.1 to 102.n. Each of these coupling plane-side coupling contacts 102.1 to 102.n is designed to establish a connection with correspondingly complementary designed coupling contacts 102.1′ to 102.n′ of the mating electrical contact coupling 101′.

Data and/or signals for different applications are transmitted via the individual coupling plane-side coupling contacts 102.1 to 102.n. For example, the first coupling contact 102.1 serves to transmit data and/or signals of the brake control system to the correspondingly complementary designed coupling contact 102.1′ of the mating electrical contact coupling 101′ while the second coupling contact 102.2 serves to transmit data and/or signals for the door control system. The other coupling contacts 102.3 to 102.n are associated with data and/or signal transmissions for other applications.

The individual coupling plane-side coupling contacts 102.1 to 102.n are integrated together into the housing of the electrical contact coupling 101. These coupling contacts 102.1 to 102.n are connected at the rear to the respectively associated car body-side coupling contacts 104.1 to 104.n by corresponding; i.e. by multiple cables 103.1 to 103.n associated with specific cable categories (EN 50343). These car body-side coupling contacts 104.1 to 104.n form the coupling-side part of an electrical coupling/train interface 105.

Since in the conventional interface arrangement 100 depicted schematically in FIG. 1 the individual applications and services (brake control, traction control, emergency brake system, door control, passenger information, etc.) are assigned to discrete coupling contacts 102.1 to 102.n in the electrical contact coupling 101, it is common in the conventional interface arrangement 100 with respect to the cabling 103.1 to 103.n to select corresponding application/service-specific cabling pursuant to the EMC cable categories (EN 50343). This has the consequence of a high number of different coupling contacts 102.1 to 102.n, lines 103.1 to 103.n and types of cables being used in the conventional interface arrangement 100, which ultimately adversely affects efforts to standardize and normalize the interface arrangement 100.

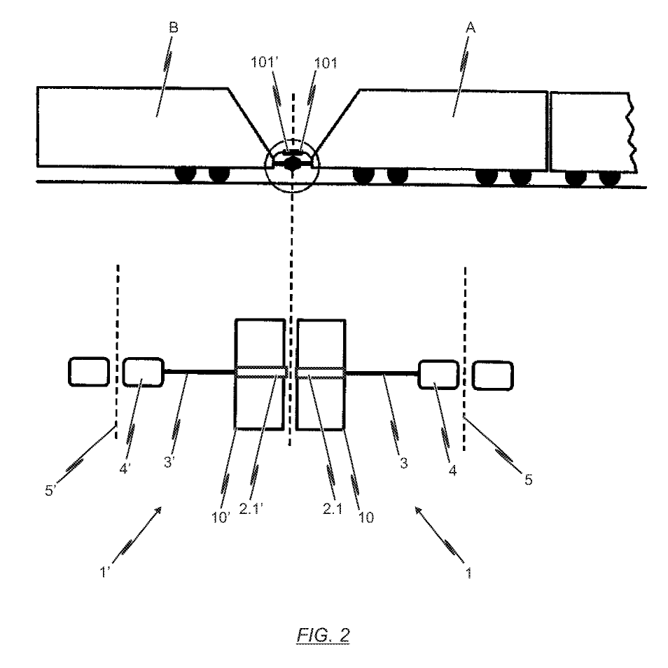

FIG. 2 shows a schematic view of an example embodiment of the interface arrangement 1 according to the invention. As also described above with respect to the known prior art interface arrangement 100 depicted in FIG. 1, the schematically depicted interface arrangement 1 according to the invention shown in FIG. 2 serves in data, signal and/or voice transmission between two adjacent car bodies A, B of a multi-member vehicle, a track-guided vehicle in particular. To this end, the interface arrangement 1 comprises an electrical contact coupling 10 associated with the first car body A which is able to be coupled to a mating electrical contact coupling 10′ designed correspondingly complementary thereto for data, signal and/or voice transmission. The electrical contact coupling 10 can be—as the schematic embodiment according to FIG. 2 indicates—arranged on the coupling head of a (mechanical) coupling, a central buffer coupling in particular, whereby the coupling head of the mechanical coupling serves in the transferring of tensile and compressive forces between the coupled car bodies A, B which occur during vehicle operation.

It is also conceivable, however, to utilize the electrical contact coupling 10 alone; i.e. without the coupling head of a (mechanical) coupling in order to enable data, signal and/or voice transmission between adjacent vehicle units (train units).

In the inventive interface arrangement 1 according to FIG. 2, the electrical contact coupling 10 comprises a coupling housing in which at least one coupling plane-side coupling contact is integrated (in the representation of FIG. 2, exactly one coupling plane-side coupling contact). This at least one coupling plane-side coupling contact 2 forms the actual interface between the electrical contact coupling 10 and the mating electrical contact coupling 10′ of the adjacent car body B.

The at least one coupling plane-side coupling contact 2 of the electrical contact coupling 10 is connected to a car body-side coupling contact 4 by a cable 3, wherein said car body-side coupling contact 4 forms a part of an electrical coupling/train interface 5.

In contrast to the known prior art conventional interface arrangement 100 according to the schematic representation provided in FIG. 1, an optimized control system structure is provided in the example embodiment of the inventive interface arrangement 1 as depicted in FIG. 2 which allows significantly reducing the number of heterogeneous individual lines (cablings 103.1 to 103.n) used in the prior art. Specifically, the example embodiment according to FIG. 2 provides for the at least one coupling plane-side coupling contact 2 of the electrical contact coupling 10 to be connected to the electrical coupling/train interface 5, or the corresponding car body-side coupling contact 4 of the electrical coupling/train interface 5 respectively, solely by data bus-capable connection technology. Using a data bus-supported connection reduced in number as cabling 3 can achieve an improvement in the maintainability, diagnosability, configurability (software) and scalability of the interface arrangement 1 as a whole.

A standardized data bus cabling; i.e. a data bus cabling of standardized EMC cable category “C” (EN 50343) as well as “D” link class (ISO/IEC 11801) is advantageously provided as cabling 3 between the at least one coupling plane-side coupling contact 2 and the at least one associated car body-side coupling contact 4 so that the structure of the electrical contact coupling 10 as well as the electrical coupling/train interface 5 can be greatly simplified.

In the embodiment of the inventive interface arrangement depicted schematically in FIG. 2, the electrical contact coupling 10 associated with the first car body A is advantageously coupled to a mating electrical contact coupling 10′ which is of complementary configuration to electrical contact coupling 10. To avoid repetition, a detailed description of the interface arrangement 1′ associated with car body B will thus be dispensed with. The corresponding components of interface arrangement 1′; i.e. the interface arrangement 1′ which is associated with the second car body B, are identified by the same reference numerals as the components of the interface arrangement 1 associated with the first car body A, whereby, however, a respective apostrophe is used with the reference numerals of the components of interface arrangement 1′ associated with the second car body B.

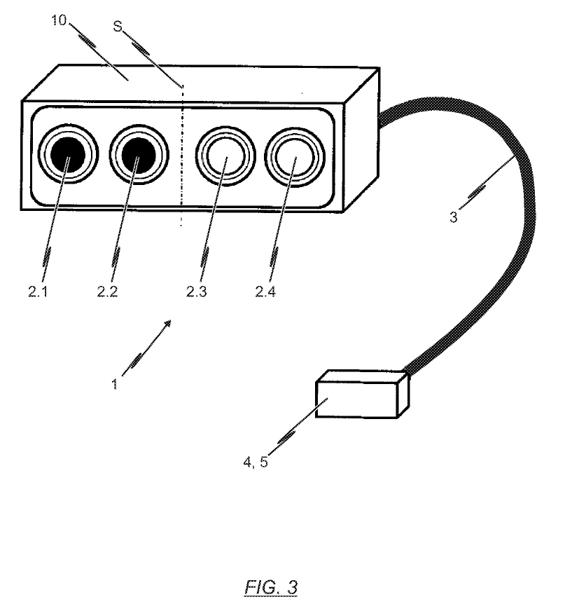

FIG. 3 shows an example embodiment of an interface arrangement 1 in an isometric representation. As depicted, a total of four coupling plane-side coupling contacts 2.1, 2.1, 2.3 and 2.4 are arranged in the coupling head of the electrical contact coupling 10. These four coupling contacts 2.1 to 2.4 are divided into groups of two and are mirror-symmetrically arranged with respect to a vertical plane of symmetry S of the electrical contact coupling 10. The coupling contacts 2.1, 2.1; 2.3, 2.4 of the respective groupings are configured correspondingly complementary to each other so as to enable coupling to a mating electrical contact coupling (not shown in FIG. 3) of complementary design to the electrical contact coupling 10.

Two data networks can be transmitted in physically separated manner via the individual coupling contacts 2.1, 2.2; 2.3, 2.4 of the respective two groupings, whereby each data network is assigned to a specific connection. The data networks can hereby be realized, for example, as Ethernet networks of e.g. link class “D” (ISO/IEC 11801).

In the embodiment of the inventive interface arrangement 1 depicted in FIG. 3, the coupling plane-side coupling contacts 2.1 to 2.4 are each designed as mechanically reversible (hermaphroditic) galvanically coupling contacts, wherein the left coupling side is equipped with coupling contacts 2.1, 2.2 of pin type (male) design and the right coupling side with those of female design.

Depending on the vehicle-side network topology and the data bus concept to be realized, additional paired data bus contacts can also be arranged in the electrical contact coupling 10.

The cabling 3 from the coupling plane-side coupling contacts 2.1 to 2.4 to the car body-side coupling contact 4 or the electrical coupling/train interface respectively remains identical in terms of EMC cable category “C” (EN 50343).

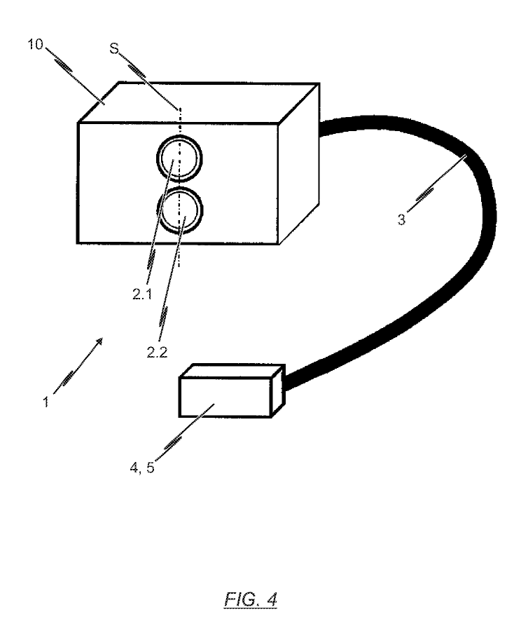

A further example embodiment of the inventive interface arrangement is shown in isometric representation in FIG. 4. In this embodiment, a non-contact-based contact technology is employed for data, signal and/or voice transmission between two adjacent electrical contact couplings. This non-contact-based contact technology can for example be an optical, electromagnetic, capacitive and/or inductive technology.

Employing non-contact-based contact technology in the coupling plane-side coupling contacts enables variable configuring of the coupling profile of the electrical contact coupling 10 since mechanical reversibility does not need to be thereby taken into account. It is in particular advantageous in conjunction hereto for the coupling plane-side coupling contacts 2.1 and 2.2 to be arranged in the vertical plane of symmetry of the electrical contact coupling 10.

The invention is not limited to the embodiments of the inventive interface arrangement depicted in the drawings but rather yields from an integrated consideration of all the features disclosed herein in context.

It is in particular conceivable in conjunction hereto for power to be supplied via the data bus-capable cabling 3 to at least the components of the electrical contact coupling (coupling contacts) or even to other data bus-connected components. Particularly ideally suited to this in the case of Ethernet network applications is the already established PoE (Power over Ethernet) system. Here as well, the cabling as per EMC cable category “C” (EN 50343) can remain identical. As previously indicated, a mechanical coupling can also be dispensed with, which thereby yields further geometrical freedom in designing the interface between two adjacent car bodies of the multi-member vehicle.

### LIST OF REFERENCE NUMERALS

1 interface arrangement
2.1 to 2.4 coupling plane-side coupling contact
3 data bus-capable cabling
4 car body-side coupling contact
5 electrical coupling/train interface
10 electrical contact coupling
100 interface arrangement (prior art)
101 electrical contact coupling (prior art)
102.1 to 102.n coupling plane-side coupling contact (prior art)
103.1 to 103.n cabling (prior art)
104.1 to 104.n car body-side coupling contact (prior art)
105 electrical coupling/train interface (prior art)
A, B car body
S vertical plane of symmetry of the electrical contact coupling

1-10. (canceled)

11. An interface arrangement for data, signal and/or voice transmission between two adjacent car bodies of a multi-member vehicle, wherein the interface arrangement comprises:
an electrical contact coupling associated with a first car body having at least one coupling plane-side coupling contact for data, signal and/or voice transmission to a mating electrical contact coupling of a second car body adjacent to the first car body, wherein the at least one coupling plane-side coupling contact is connected to a car body-side coupling contact of an electrical coupling/train interface solely by means of a data bus cabling.

12. The interface arrangement according to claim 11, wherein the data bus cabling is a data bus-capable cabling which, in terms of a specification of a transmission path, is of a predefined standardized EMC cable category and a specified link class.

13. The interface arrangement according to claim 11, wherein the data bus-capable cabling belongs to class “D” pursuant to the ISO/IEC.

14. The interface arrangement according claim 11, wherein the at least one coupling plane-side coupling contact is connected to the car body-side coupling contact of the electrical coupling/train interface solely by the data bus cabling.

15. The interface arrangement according to claim 11, wherein the data bus cabling provides at least two physically separate transmission paths for different services.

16. The interface arrangement according to claim 15, wherein at least one transmission path provided by the data bus cabling for data, signal and/or voice transmission is for a vehicle control system, and wherein at least one other transmission path provided by the data bus cabling for data, signal and/or voice transmission is for a vehicle entertainment system.

17. The interface arrangement according to claim 11, wherein the at least one coupling plane-side coupling contact further comprises at least one data bus plug connection and/or at least one non-contact-based coupling contact.

18. The interface arrangement according to claim 11, wherein the electrical contact coupling further comprises at least one first coupling plane-side coupling contact and at least one second coupling plane-side coupling contact of complementary design with respect to the at least one first coupling plane-side coupling contact for transmitting at least two physically separate Ethernet networks, wherein the at least one first coupling plane-side coupling contact and the at least one second coupling plane-side coupling contact are mirror-symmetrically arranged with respect to a vertical plane of symmetry of the electrical contact coupling.

19. The interface arrangement according to one of claim 11, wherein the at least one coupling plane-side coupling contact is arranged on a vertical plane of symmetry of the electrical contact coupling, wherein the at least one coupling plane-side coupling contact is for non-contact-based data, signal and/or voice transmission.

20. An automatic central buffer coupling for a track-guided vehicle for mechanically connecting two adjacent car bodies of a multi-member vehicle, wherein the automatic central buffer coupling further comprises the interface arrangement according to claim 11.
